(19) United States
(12) Patent Application Publication
(10) Pub. No.: US 2009/0020108 A1
(43) Pub. Date: Jan. 22, 2009

(54) Barbecue grill with multiple adjustable grids

(76) Inventor: Tzu-Yun Chiang, Fongyuan City (TW)

Correspondence Address: COOPER & DUNHAM, LLP, 1185 AVENUE OF THE AMERICAS, NEW YORK, NY, 10036, US

(21) Appl. No.: 11/879,331

(22) Filed: Jul. 17, 2007

(51) Int. Cl. A47J 37/07

(52) U.S. Cl. 126/25 R

(57) ABSTRACT

A barbecue grill has a stand, a body, multiple grids and multiple adjusting devices. The body is attached to the top of the stand. The grids are adjustably mounted on the body. The adjusting devices are mounted respectively between the body and the grids to adjustably mount the grid on the body. Each adjusting device has a shaft and a positioning device. The shaft moveably extends through the body and is rotatably connected to a corresponding grid. The positioning device is mounted between the body and the corresponding grid and is connected to the shaft to hold the shaft at a desired position. Accordingly, the grids can be positioned at different horizontal levels and rotated away from the body, such that the use of the barbecue grill is convenient and versatile.

### BACKGROUND OF THE INVENTION

1. Field of the Invention

The present invention relates to a barbecue grill, and more particularly to a barbecue grill with multiple grids adjustable in height and moveable to make the barbecue grill versatile and convenient in use.

2. Description of Related Art

A conventional barbecue grill substantially comprises a stand and a body supported on the stand to roast or toast food. In use, a heat generator, such as gas stove or charcoal fire is mounted on the body for generating heat. A grid is separately mounted on the body to support food to be roasted or toasted by the heat generated by the heat generator.

However, the grid on the conventional barbecue grill is not adjustable and not moveable, the grid must be removed away from the body is necessary for adding charcoal into the body so that the use of the conventional barbecue grill is inconvenient. The user must pick the roasted food from the grid above the heat generator at a high temperature condition, but the user is easily burned. In additional, the temperate degree applied to the foods held on the grid is same but does not fit with roasting different kinds of foods, such as vegetables, meets or fishes. Thus, some foods are easily burned, but some foods are half-baked.

To overcome the shortcomings, the present invention tends to provide a barbecue grill with multiple adjustable grids to mitigate or obviate the aforementioned problems.

### SUMMARY OF THE INVENTION

The main objective of the invention is to provide a barbecue grill that has multiple adjustable grids and is convenient and versatile in use. The barbecue grill has a stand, a body, multiple grids and multiple adjusting devices. The body is attached to the top of the stand. The grids are adjustably mounted on the body. The adjusting devices are mounted respectively between the body and the grids to adjustably mount the grid on the body. Each adjusting device has a shaft and a positioning device. The shaft moveably extends through the body and is rotatably connected to a corresponding grid. The positioning device is mounted between the body and the corresponding grid and is connected to the shaft to hold the shaft at a desired position. With such an arrangement, the grids can be positioned at different horizontal levels and rotated away from the body when the user wants to add charcoal into the body or pick the roasted food from the grid. Thus, the use of the barbecue grill is convenient and versatile.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a barbecue grill in accordance with the present invention;

FIG. 2 is an enlarged exploded perspective view of the leg and the body of the adjusting device of the barbecue grill in FIG. 1;

FIG. 3 is an enlarged exploded perspective view of one adjusting device of the adjusting device of the barbecue grill in FIG. 1;

FIG. 4 is an operational perspective view of the barbecue grill in FIG. 1 showing that the grids are positioned at different horizontal levels; and

FIG. 5 is an operational perspective view of the barbecue grill in FIG. 1 showing that one of the grids is rotated away from the body.

### DETAILED DESCRIPTION OF PREFERRED EMBODIMENT

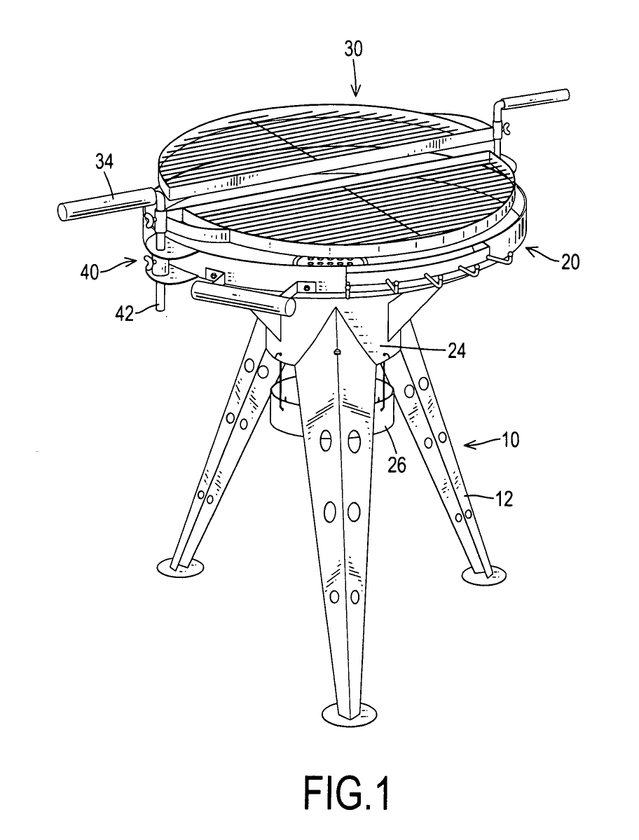

With reference to FIG. 1, a barbecue grill in accordance with the present invention comprises a stand (10), a body (20), multiple grids (30) and multiple adjusting devices (40).

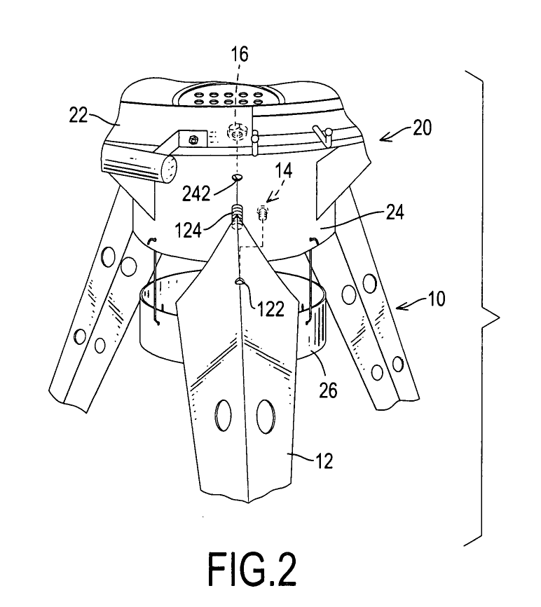

With further reference to FIG. 2, the stand (10) has a top and comprises three legs (12). The legs (12) are securely attached to the body (10) with fasteners (14).

The body (20) is attached to and supported on the top of the stand (10). The body (20) comprises a bowl (22), a leg mount (24) and an ash catcher (26). The bowl (22) has a bottom. The leg mount (24) is attached to the bottom of the bowl (22) and has a bottom. The ash catcher (26) is securely attached to the bottom of the leg mount (24). In a preferred embodiment, the legs (12) of the stand (10) are secured onto the leg mount (24) of the body (20) with the fasteners (14). Additionally, each leg (12) has a top, a bolt (124) securely attached to the top of the leg (12) and a threaded hole (122) defined in the top. The leg mount (24) has multiple through holes (242) defined through the leg mount (24) and corresponding to the bolts (124) and the threaded holes (122) in the legs (12). The fasteners (14) extend through the through holes (242) in the leg mount (24) and are screwed into the threaded holes (122) in the legs (12). The bolts (124) on the legs (12) extend respectively through the through holes (242) in the leg mount (24) and are screwed with nuts (42). Accordingly, the legs (12) are securely attached to the leg mount (24).

The grids (30) are adjustably mounted on the body (20). In the preferred embodiment, the barbecue grill comprises two grids (30), and each grid (30) is semicircular.

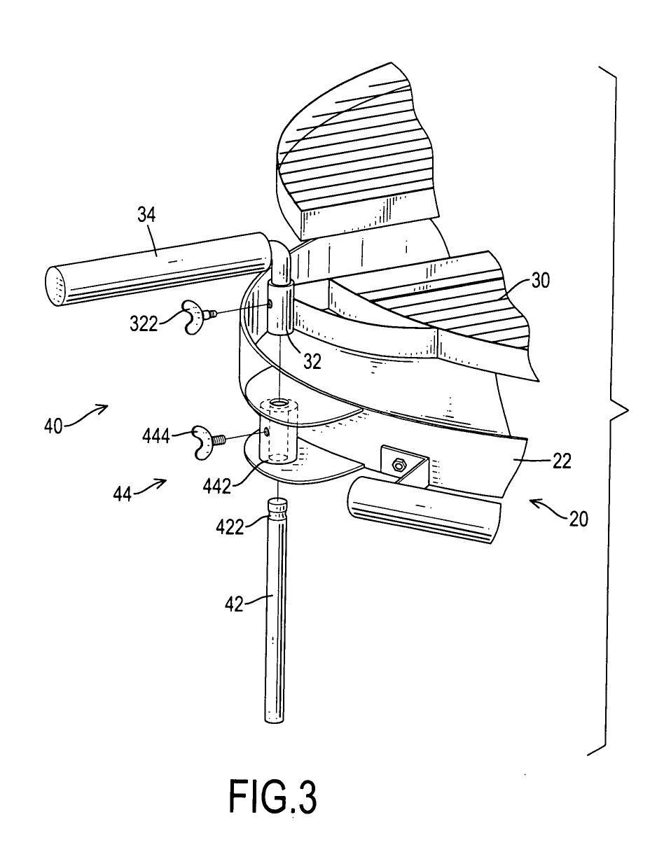

With further reference to FIG. 3, the adjusting devices (40) are mounted respectively between the bowl (22) of the body (20) and the grids (30) to adjustably mount the grids (30) on the body (20). Each adjusting device (40) comprises a shaft (42) and a positioning device (44). The shaft (42) moveably extends through the body (20) and is rotatably connected to the corresponding grid (30). To rotatably connect the shaft (42) to the grid (30), a tube (32) is securely mounted on the grip (30) and has a bottom opening. The shaft (42) has a top extending into the bottom opening of the tube (32) and an annular groove (422) defined near the top. A holding screw (322) is screwed into the tube (32) and has a free end extending into the groove (422) in the shaft (42) to rotatably hold the shaft (42) in the tube (32). With the engagement between free end of the holding screw (322) and the groove (422) in the shaft (42), the grid (30) can rotate relative to the corresponding shaft (42). In addition, a handle (34) is mounted on each tube (32) for conveniently rotating the grid (30) relative to the shaft (42).

The positioning device (44) is mounted between the body (20) and the corresponding grid (30) and is connected to the shaft (42) to hold the shaft (42) with the corresponding grid (30) at a desired position. The positioning device (44) comprises a tubular member (442) and a positioning screw (444). The tubular member (442) is formed on the body (20) and has a through hole extending through the tubular member (442) for the shaft (42) extending through the through hole. The positioning screw (444) is screwed into the tubular member (442) and has a free end abutting against the shaft (42) to hold the shaft (42) in place. With the abutment between the free end of the positioning screw (444) and the shaft (42), the shaft (42) can be positioned at any desired position so that the corresponding grid (30) can also be held at any desired position.

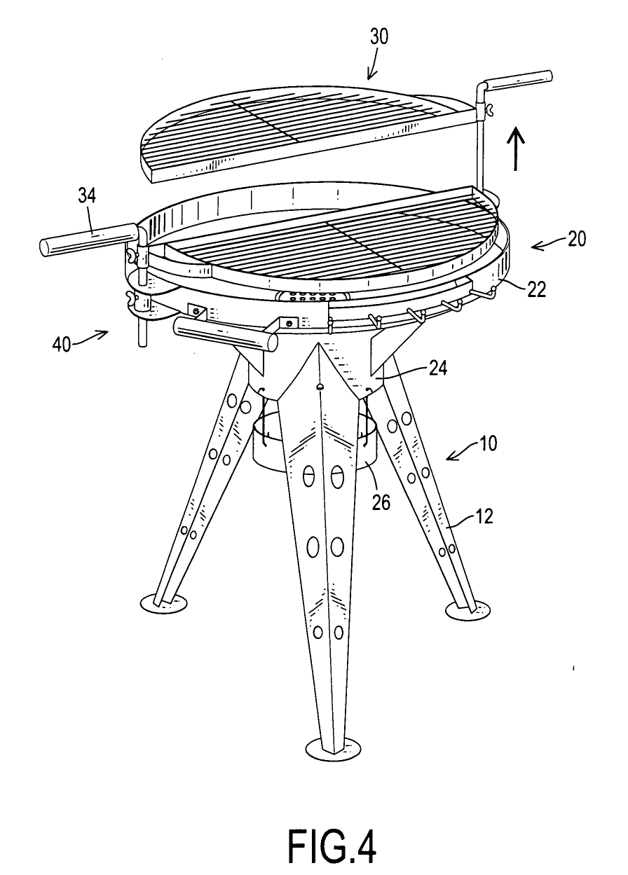

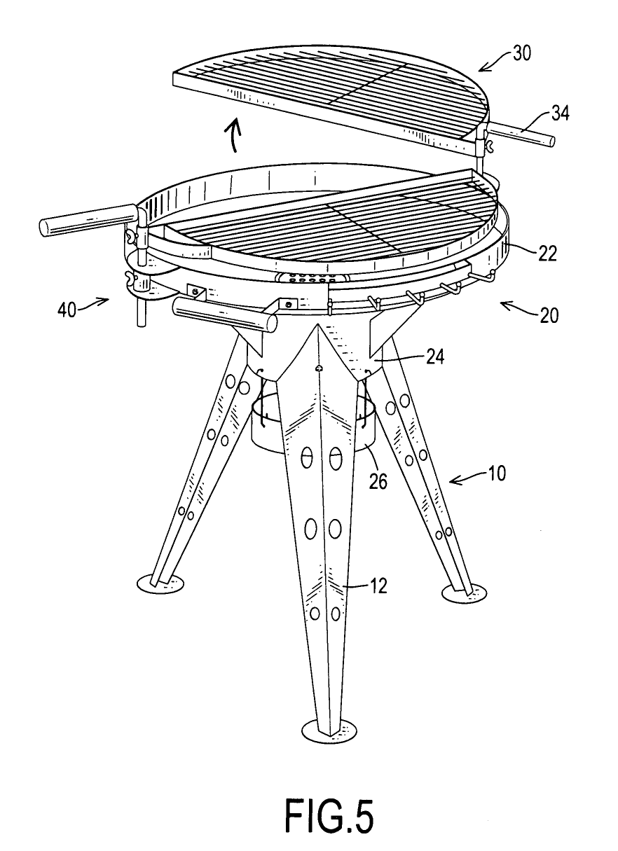

With such a barbecue grill, with further reference to FIGS. 4 and 5, the heights of the grids (30) relative to the body (20) can be adjusted at different horizontal levels by means of releasing the positioning screws (444) and moving the shafts (42) along the tubular members (442). With different horizontal levels of the grids (30), heat generated by a heat generator can be applied to the foods on the grids (30) at different temperature degrees. Thus, different kinds of foods, such as vegetables, meets or fishes can be held on different grids (30) to be roasted at different temperature degrees to keep the foods from being burned or half-baked

In addition, any grid (30) can be rotated relative to the corresponding shaft (42) and away from the body (20), such that the user can add charcoal into the body (20) conveniently. In addition, the user will not be burned when the user picks the roasted food from the removed grid (30), such that the use of the barbecue grill is convenient and versatile.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A barbecue grill comprising:
a stand with a top;
a body attached to the top of the stand; and
multiple grids adjustably mounted on the body; and
multiple adjusting devices mounted respectively between the body and the grids to adjustably mount the grid on the body, wherein each adjusting device comprises
a shaft moveably extending through the body and rotatably connected to a corresponding one of the grids; and
a positioning device mounted between the body and the corresponding grid and connected to the shaft to hold the shaft at a desired position.

2. The barbecue grill as claimed in claim 1, wherein the positioning device of each adjusting device comprises
a tubular member formed on the body and having a through hole extending through the tubular member for the shaft of the adjusting device extending through the through hole; and
a positioning screw screwed into the tubular member and having a free end abutting against the shaft to hold the shaft in place.

3. The barbecue grill as claimed in claim 2, wherein
each grip further has a tube securely mounted on the grip and having a bottom opening;
the shaft of each adjusting device has a top extending into the bottom opening of the tube on a corresponding grid and an annular groove defined near the top; and
multiple holding screws screwed respectively into the tubes on the grids and each has a free end extending into the groove in a corresponding shaft to rotatably hold the corresponding shaft in a corresponding tube.

4. The barbecue grill as claimed in claim 3 further comprising the tube of each adjusting device further has a handle mounted on the tube.

5. The barbecue grill as claimed in claim 4, wherein the barbecue grill has two grids and each grid is semicircular.

6. The barbecue grill as claimed in claim 5, wherein
the body comprises
a bowl having a bottom;
a leg mount attached to the bottom of the bowl and having a bottom; and
an ash catcher securely attached to the bottom of the leg mount; and
the stand has three legs secured onto the leg mount of the body with fasteners.

7. The barbecue grill as claimed in claim 6, wherein
each leg of the stand has a top, a bolt securely attached to the top of the leg and a threaded hole defined in the top;
the leg mount has multiple through holes defined through the leg mount and corresponding to the bolts and the threaded holes in the legs;
the fasteners extend through corresponding through holes in the leg mount and are screwed into the threaded holes in the legs; and
the bolts on the legs extend respectively through corresponding through holes in the leg mount and are screwed with nuts.

8. The barbecue grill as claimed in claim 1, wherein
each grip further has a tube securely mounted on the grip and having a bottom opening;
the shaft of each adjusting device has a top extending into the bottom opening of the tube on a corresponding grid and an annular groove defined near the top; and
two holding screws screwed respectively into the tubes and each has a free end extending into the groove in a corresponding shaft to rotatably hold the corresponding shaft in a corresponding tube.

9. The barbecue grill as claimed in claim 8 further comprising the tube of each adjusting device further has a handle mounted on the tube.

10. The barbecue grill as claimed in claim 9, wherein the barbecue grill has two grids and each grid is semicircular.

11. The barbecue grill as claimed in claim 10, wherein
the body comprises
a bowl having a bottom;
a leg mount attached to the bottom of the bowl and having a bottom; and
an ash catcher securely attached to the bottom of the leg mount; and
the stand has three legs secured onto the leg mount of the body with fasteners.

12. The barbecue grill as claimed in claim 11, wherein
each leg of the stand has a top, a bolt securely attached to the top of the leg and a threaded hole defined in the top;
the leg mount has multiple through holes defined through the leg mount and corresponding to the bolts and the threaded holes in the legs;
the fasteners extend through corresponding through holes in the leg mount and are screwed into the threaded holes in the legs; and
the bolts on the legs extend respectively through corresponding through holes in the leg mount and are screwed with nuts.

13. The barbecue grill as claimed in claim 1, wherein the barbecue grill has two grids and each grid is semicircular.

14. The barbecue grill as claimed in claim 1, wherein
the body comprises
a bowl having a bottom;
a leg mount attached to the bottom of the bowl and having a bottom; and
an ash catcher securely attached to the bottom of the leg mount; and
the stand has three legs secured onto the leg mount of the body with fasteners.

15. The barbecue grill as claimed in claim 14, wherein
each leg of the stand has a top, a bolt securely attached to the top bf the leg and a threaded hole defined in the top;
the leg mount has multiple through holes defined through the leg mount and corresponding to the bolts and the threaded holes in the legs;
the fasteners extend through corresponding through holes in the leg mount and are screwed into the threaded holes in the legs; and
the bolts on the legs extend respectively through corresponding through holes in the leg mount and are screwed with nuts.
